(19) United States
(12) Patent Application Publication
(10) Pub. No.: US 2023/0344108 A1
(43) Pub. Date: Oct. 26, 2023

(54) Resonant Structure for Controlling Harmonic Distances, and Dielectric Filter

(71) Applicants: WUGUANG SYSTEM COMPANY LIMITED, Hong Kong (CN); ACCULA ELECTRONIC TECHNOLOGIES PTE. LTD, SINGAPORE (SG); AVALEN INFO SYSTEM TECHNOLOGIES COMPANY LIMITED, British Columbia (CA)

(72) Inventor: Qingnan MENG, Wuhan,Hubei (CN)

(21) Appl. No.: 17/797,449

(22) PCT Filed: May 24, 2021
(86) PCT No.: PCT/CN2021/095573

§ 371 Date: Aug. 4, 2022

(30) Foreign Application Priority Data
Aug. 7, 2020 (CN) 202010792915.6

(51) Int. Cl. H01P 7/10; H01P 1/20

(52) U.S. Cl. CPC H01P 7/105; H01P 1/2002

(57) ABSTRACT

The present application provides a dielectric resonant structure for controlling harmonic distances, including a cavity, a support frame, a dielectric resonator and a cover plate, wherein the cavity is composed of a sealed space, and one surface of the cavity is a cover plate surface; the dielectric resonator is composed of a dielectric; the dielectric resonator is installed in the cavity; and the support frame is installed at any position between the dielectric resonator and an inner wall of the cavity, matches any shape of the dielectric resonator and the cavity, and is connected to, fixed with, and supported the dielectric resonator. The dielectric resonator is partially provided with a blind slot, a through slot, a blind hole or a through hole, or is provided with a protrusion on its surface, so as to change the span of frequency between a fundamental mode and the span of frequency high-order mode or between the high-order mode and a higher-order mode. When the set materials and dimensions of the cavity, the dielectric resonator and the support frame remain unchanged, most filters require the frequency of the high-order mode to be as far away from a passband as possible, so as to reduce the interference to a main passband. The dielectric resonator of the present application is capable of conveniently controlling harmonic distances of the filter and flexibly changing the attenuation performance outside the passband.

### TECHNICAL FIELD

Embodiments of the present invention relate to the technical field of communications, and in particular, to a resonant structure for controlling harmonic distances, and a dielectric filter.

### BACKGROUND

Microwave passive devices are extremely important constituent parts in modern microwave and millimeter wave communication systems, and microwave filter is one of indispensable devices in these microwave passive devices. With the rapid development of communication business and the increasing shortage of radio spectrum resources, performance indexes of passive filters are required to be changed, the insertion loss is required to be lower, the volume is required to be smaller, and out-of-band attenuation requirements are more strict. A novel functional ceramic material appeared in recent years has the characteristics of a high dielectric constant, high Q and low temperature offset, and thus is applied to the passive filters, but the filters composed of the ceramic material have closer harmonic waves than a traditional cavity filter. When the set materials and dimensions of cavity, a dielectric resonator and a support frame remain unchanged, most filters require the frequency of a high-order mode to be as far away from a passband as possible, so as to reduce the interference to a main passband. A few filters require the frequency of the high-order mode to be close to the passband, so as to form a multi-passband filter. Therefore, how to control the span of frequency between a required fundamental mode and a high-order mode is a challenge for a dielectric resonant structure.

Therefore, it is necessary to design a new dielectric resonant structure to improve the span of frequency between the fundamental mode and the high-order mode.

### SUMMARY

In order to solve the above problem, an embodiment of the present invention provides a dielectric resonant structure for controlling harmonic distances, which can solve the problem of the span of frequency between a fundamental mode and a high-order mode.

The embodiment of the present invention provides a dielectric resonant structure for controlling harmonic distances, including a cavity, a support frame, a dielectric resonator and a cover plate, wherein the cavity is composed of a sealed space, and one surface of the cavity is a cover plate surface; the dielectric resonator is composed of dielectric; the dielectric resonator is installed in the cavity and is not in contact with an inner wall of the cavity; the support frame is installed at any position between the dielectric resonator and the inner wall of the cavity, matches any shape of the dielectric resonator and the cavity, and is connected to, fixed with and supported the dielectric resonator; the cavity is internally provided with a uniaxial cylindrical or polygonal dielectric resonator and the support frame fixed thereon, so as to form a multi-mode dielectric resonant structure with the cavity; the cavity is internally provided with two vertically intersecting cylindrical or polygonal uniaxial dielectric resonators and the support frame fixed thereon, so as to form a multi-mode dielectric resonant structure with the cavity, wherein an X axis dimension of the cylindrical or polygonal dielectric resonator on an X axis is greater than or equal to a dimension, in a vertical direction and parallel to the X axis, of the cylindrical or polygonal dielectric resonator on a Y axis, and a Y axis dimension of the cylindrical or polygonal dielectric resonator on the Y axis is greater than or equal to a dimension, in the vertical direction and parallel to the Y axis, of the cylindrical or polygonal dielectric resonator on the X axis; the cavity is internally provided with three vertically intersecting cylindrical or polygonal uniaxial dielectric resonators and the support frame fixed thereon, so as to form a multi-mode dielectric resonant structure with the cavity, wherein the X axis dimension of the cylindrical or polygonal dielectric resonator on the X axis is greater than or equal to the dimensions, in the vertical direction and parallel to the X axis, of the cylindrical or polygonal dielectric resonator on the Y axis and the cylindrical or polygonal dielectric resonator on a Z axis; the Y axis dimension of the cylindrical or polygonal dielectric resonator on the Y axis is greater than or equal to the dimensions, in the vertical direction and parallel to the Y axis, of the cylindrical or polygonal dielectric resonator on the X axis and the cylindrical or polygonal dielectric resonator on the Z axis; a Z axis dimension of the cylindrical or polygonal dielectric resonator on the Z axis is greater than or equal to the dimensions, in the vertical direction and parallel to the Z axis, of the cylindrical or polygonal dielectric resonator on the X axis and the cylindrical or polygonal dielectric resonator on the Y axis, wherein the dielectric resonator is partially provided with a blind slot, a through slot, a blind hole or a through hole, or is provided with a protrusion on its surface; or, slots, holes or protrusions are symmetrically formed in the axial direction of the dielectric resonator; or, slots or holes are formed in any surface, edge or corner of the dielectric resonator; or, a protrusion is arranged on the surface of the dielectric resonator. The dielectric resonator is partially provided with the blind slot, the through slot, the blind hole or the through hole, or is provided with the protrusion on its surface, so as to change the span of frequency between a fundamental mode and a high-order mode or the span of frequency between the high-order mode and the higher-order mode.

Optionally, the dielectric resonant structure is composed of a uniaxial dielectric resonator, vertically intersecting uniaxial dielectric resonators or three vertically intersecting uniaxial dielectric resonators, slots or holes are formed in corners, edges, surfaces or interior of the dielectric resonator, and a plurality of slots or holes are symmetrically formed in different corners, edges and surfaces; or, a plurality of slots or holes are formed in the same surface; or, slots or holes are formed inside the dielectric resonator; or, slots or holes are symmetrically formed in different axial directions thereof.

Optionally, the slots or holes formed in the dielectric resonator are set as blind slots, blind holes, through slots or through holes, and under the condition that the frequency of the fundamental mode is kept unchanged, the dimension of the dielectric resonator changes after the slots and the holes are formed, so as to change the span of frequency between the fundamental mode and the high-order mode or between the high-order mode and the higher-order mode.

Optionally, the protrusion is arranged at any position on any of the surfaces of the dielectric resonator, the protrusion is a cuboid, a cylinder or an irregular shape, and under the condition that the frequency of the fundamental mode is kept unchanged, the dimension of the dielectric resonator changes after the protrusion is arranged, so as to change the span of frequency between the fundamental mode and the high-order mode or between the high-order mode and the higher-order mode.

Optionally, when the dielectric resonant structure is composed of a uniaxial dielectric resonator, vertically intersecting uniaxial dielectric resonators or three vertically intersecting uniaxial dielectric resonators, horizontal and vertical dimensions of the dielectric resonator are trimmed, slotted and chamfered, so that the dimension of the inner wall of the cavity and the dimensions of three corresponding axial dielectric resonators are changed or the dimensions in horizontal and vertical directions of the dielectric resonators are changed, so as to change the frequency of the fundamental mode and the frequency of multiple high-order modes, as well as the corresponding number of multi-modes and Q values; and when the dielectric resonant structure is composed of vertically intersecting uniaxial dielectric resonators or three vertically intersecting uniaxial dielectric resonators, and when the dimension of any axial cylindrical or polygonal dielectric resonator is less than the dimension, in the vertical direction and parallel to the axial direction, of the other one or two axial cylindrical or polygonal dielectric resonators, the frequency of the corresponding fundamental mode and the frequency of multiple high-order modes, as well as the corresponding number of multi-modes and the Q values change accordingly, when the frequency of the fundamental mode is kept constant, in the dielectric resonator structure for controlling harmonic distances, which is composed of the dielectric resonators with different dielectric constants, the cavity and the support frame, the multi-modes and the Q values corresponding to the frequency of the fundamental mode and the multiple high-order modes will change, the Q values of the dielectric resonators with different dielectric constants will change differently, and meanwhile, the frequency of the high-order mode will also change.

Optionally, the cavity is internally provided with a uniaxial cylindrical or polygonal dielectric resonator and the support frame fixed thereon, so as to form a multi-mode dielectric resonant structure with the cavity, the center of an face of the dielectric resonator approaches to or coincides with a central position of a corresponding inner wall surface of the cavity, the horizontal and vertical dimensions of the dielectric resonator are trimmed, slotted and chamfered, so that the dimension of the inner wall of the cavity and the dimensions of three corresponding axial dielectric resonators are changed or the dimensions in horizontal and vertical directions of the dielectric resonators are changed, so as to change the frequency of the fundamental mode and the frequency of multiple high-order modes, as well as the corresponding number of multi-modes and Q values, when the X axis, Y axis and Z axis dimensions of the inner wall of the cavity change, and when at least one required frequency is kept unchanged, the X axis, Y axis and Z axis dimensions of the dielectric resonator corresponding to the inner wall of the cavity will also change accordingly; the cavity is internally provided with two vertically intersecting cylindrical or polygonal uniaxial dielectric resonators and the support frame fixed thereon, so as to form a multi-mode dielectric resonant structure with the cavity, the center of the face of the dielectric resonator approaches to or coincides with the central position of the corresponding inner wall surface of the cavity, wherein the X axis dimension of the cylindrical or polygonal dielectric resonator on the X axis is greater than or equal to the dimension, in the vertical direction and parallel to the X axis, of the cylindrical or polygonal dielectric resonator on the Y axis, and the Y axis dimension of the cylindrical or polygonal dielectric resonator on the Y axis is greater than or equal to the dimension, in the vertical direction and parallel to the Y axis, of the cylindrical or polygonal dielectric resonator on the X axis; the horizontal and vertical dimensions of the dielectric resonator are trimmed, slotted and chamfered, so that the dimension of the inner wall of the cavity and the dimensions of three corresponding axial dielectric resonators are changed or the dimensions in horizontal and vertical directions of the dielectric resonators are changed, so as to change the frequency of the fundamental mode and the frequency of multiple high-order modes, as well as the corresponding number of multi-modes and the Q values, when the X axis, Y axis and Z axis dimensions of the inner wall of the cavity change, and when the required frequency is kept unchanged, the X axis, Y axis and Z axis dimensions of the dielectric resonator corresponding to the inner wall of the cavity will also change accordingly; the cavity is internally provided with three vertically intersecting cylindrical or polygonal uniaxial dielectric resonators and the support frame fixed thereon, so as to form a multi-mode dielectric resonant structure with the cavity, the center of the face of the dielectric resonator approaches to or coincides with the central position of the corresponding inner wall surface of the cavity, wherein the X axis dimension of the cylindrical or polygonal dielectric resonator on the X axis is greater than or equal to the dimensions, in the vertical direction and parallel to the X axis, of the cylindrical or polygonal dielectric resonator on the Y axis and the cylindrical or polygonal dielectric resonator on the Z axis; the Y axis dimension of the cylindrical or polygonal dielectric resonator on the Y axis is greater than or equal to the dimensions, in the vertical direction and parallel to the Y axis, of the cylindrical or polygonal dielectric resonator on the X axis and the cylindrical or polygonal dielectric resonator on the Z axis; the Z axis dimension of the cylindrical or polygonal dielectric resonator on the Z axis is greater than the dimensions, in the vertical direction and parallel to the Z axis, of the cylindrical or polygonal dielectric resonator on the X axis and the cylindrical or polygonal dielectric resonator on the Y axis; and the horizontal and vertical dimensions of the dielectric resonator are trimmed, slotted and chamfered, so that the dimension of the inner wall of the cavity and the dimensions of three corresponding axial dielectric resonators are changed or the dimensions in horizontal and vertical directions of the dielectric resonators are changed, so as to change the frequency of the fundamental mode and the frequency of multiple high-order modes, as well as the corresponding number of multi-modes and the Q values, when the X axis, Y axis and Z axis dimensions of the inner wall of the cavity change, and when the required frequency is kept unchanged, the X axis, Y axis and Z axis dimensions of the dielectric resonator corresponding to the inner wall of the cavity will also change accordingly.

Optionally, in the case of a uniaxial dielectric resonant structure or vertically intersecting uniaxial dielectric resonant structures or three vertically intersecting uniaxial dielectric resonant structures, the dielectric resonator is partially provided with slots or holes, wherein when the slots or holes are formed in an electric field dispersion area of an adjacent high-order mode, and the frequency span between the fundamental mode and the adjacent high-order mode or the frequency span between the high-order mode and the higher-order mode is less than the frequency span when the slots or holes are formed in an electric field concentration area; when the slots or holes are formed in the electric field concentration area of the adjacent high-order mode, the frequency span between the fundamental mode and the adjacent high-order mode or the frequency span between the high-order mode and the higher-order mode is greater than the frequency span when the slots or holes are formed in the electric field dispersion area, the dielectric resonator is partially provided with slots or holes, and if the volume occupied by the slots or holes is small, the frequency span between the fundamental mode and the adjacent high-order mode or the frequency span between the high-order mode and the higher-order mode is small; if the volume occupied by the slots or holes is large, the frequency span between the fundamental mode and the adjacent high-order mode or the frequency span between the high-order mode and the higher-order mode is large; if the number of the slots or holes is small, the frequency span between the fundamental mode and the adjacent high-order mode or the frequency span between the high-order mode and the higher-order mode is small; and if the number of the slots or holes is large, the frequency span between the fundamental mode and the adjacent high-order mode or the frequency span between the high-order mode and the higher-order mode is large.

Optionally, in the case of the uniaxial dielectric resonant structure or the vertically intersecting uniaxial dielectric resonant structures or the three vertically intersecting uniaxial dielectric resonant structures, the dielectric resonator is partially provided with protrusions, when the protrusions are arranged in the electric field dispersion area of the high-order mode, and the frequency span between the fundamental mode and the adjacent high-order mode or the frequency span between the high-order mode and the higher-order mode is greater than the frequency span when the protrusions are arranged in the electric field concentration area; the protrusions are arranged in the electric field concentration area of the high-order mode, the frequency span between the fundamental mode and the adjacent high-order mode or the frequency span between the high-order mode and the higher-order mode is less than the frequency span when the protrusions are arranged in the electric field dispersion area, the dielectric resonator is partially provided with the protrusions, and if the volume occupied by the area of the protrusions is small, the frequency span between the fundamental mode and the adjacent high-order mode or the frequency span between the high-order mode and the higher-order mode is small; and if the volume occupied by the area of the protrusions is large, the frequency span between the fundamental mode and the adjacent high-order mode or the frequency span between the high-order mode and the higher-order mode is large.

Optionally, in the case of the uniaxial dielectric resonant structure or the vertically intersecting uniaxial dielectric resonant structures or the three vertically intersecting uniaxial dielectric resonant structures, when the dimension of the inner wall of the cavity and the dimensions of three corresponding axial dielectric resonators are changed or the dimensions in horizontal and vertical directions of the dielectric resonators are changed, the multi-modes and the Q values corresponding to the frequency of the fundamental mode and the frequency of multiple high-order modes will change, the Q values of the dielectric resonators with different dielectric constants will change differently, when the frequency of the fundamental mode is kept unchanged, the span of frequency between the high-order mode and the fundamental mode, and the span of frequency between the high-order mode and the higher-order mode will change multiple times, the span of frequency of the dielectric resonators with different dielectric constants also change differently, wherein the size of the Q value changes when the ratios of the dimension of the inner wall of the cavity to the dimensions of the three corresponding axial dielectric resonators or the horizontal and vertical dimensions are certain ratios, the size of the Q value is proportional to a change in the size of the dimension ratio, or the size of the Q value is proportional to the change in the size of the dimension ratio and the Q value has greater changes in the vicinity of several certain specific ratios, the multi-mode Q values corresponding to different frequencies change differently in the vicinity of the several certain specific ratios, when the dimension of the cavity and the frequency of the fundamental mode are kept unchanged, and when the horizontal and vertical dimensions of the three axial dimensions of the uniaxial dielectric resonator are arbitrarily combined for change, the fundamental mode of the uniaxial dielectric resonant structure can form 1-3 multi-modes with the same frequency or similar frequency, and multiple high-order modes with different frequencies form 1-N multi-modes under the same frequency; and the fundamental mode of a vertically intersecting biaxial dielectric resonator structure or vertically intersecting triaxial dielectric resonator structure can form 1-6 multi-modes with the same frequency or similar frequency, multiple high-order modes with different frequencies form 1-N multi-modes under the same frequency, and in the case of a change in the dimension of the cavity that corresponds to one axial dielectric resonator and the other one or two axial dielectric resonators or three axial dielectric resonators, the corresponding the span of frequency between the fundamental mode and the high-order mode or the span of frequency between the high-order mode and the higher-order mode, the Q value and the modulus will also change accordingly.

Optionally, edges or sharp corners of the dielectric resonator or/and the cavity or/and the dielectric resonator are trimmed to form adjacent coupling, the cavity and the dielectric resonator are cut into triangles or quadrilaterals, or the edges of the cavity or the dielectric resonator are partially or completely cut off, the cavity and the dielectric resonator are trimmed at the same time or separately, after the adjacent coupling is formed by trimming, the frequency and the Q value will change correspondingly, the adjacent coupling changes its cross coupling, a sharp corner position at the intersection of three surfaces of the cavity corresponding to the uniaxial dielectric resonator or the vertically intersecting uniaxial dielectric resonators or the three mutually vertically intersecting uniaxial dielectric resonators is chamfered or is chamfered with the cavity and closed to form cross coupling, and the corresponding frequency and the Q value will also change correspondingly, the adjacent coupling will be changed at the same time, and when the dielectric resonator is provided with the slots or holes or protrusions at the corners and edges, the strength of the adjacent coupling and the cross coupling will be changed.

Optionally, the shape of the cavity corresponding to the uniaxial dielectric resonant structure or the vertically intersecting uniaxial dielectric resonant structures or the three vertically intersecting uniaxial dielectric resonant structures includes, but is not limited to, a cuboid, a cube and a polygon, the inner wall surface or an inner area of the cavity can be partially provided with a depression or a protrusion or a cut corner or a slot, at least one tuning device is arranged at a field strength concentration position of the dielectric resonator and is installed on the cavity, the material of the cavity is metal or non-metal, and the surface of the space is electroplated with copper or silver.

Optionally, a cross-sectional shape of the uniaxial dielectric resonator or the vertically intersecting uniaxial dielectric resonators or the three vertically intersecting uniaxial dielectric resonators includes, but is not limited to, a cylinder, an ellipsoid and a polygon, and slots or holes are formed in the corners, edges or surfaces of the dielectric resonator; or, a plurality of slots or holes are symmetrically formed in different corners, edges and surfaces; or, a plurality of slots or holes are formed in the same surface; or, slots or holes are formed inside the dielectric resonator; or, slots or holes are symmetrically formed in different axial directions of the dielectric resonator; or, a plurality of slots or holes are formed in the same surface; or, protrusions of a cylindrical or a polygonal are arranged on the surface of the dielectric resonator; or, different numbers of protrusions are arranged at any position on any surface of the dielectric resonator, the uniaxial dielectric resonator or the vertically intersecting uniaxial dielectric resonators or the three vertically intersecting uniaxial dielectric resonators are solid or hollow, the dielectric resonator is made of ceramic, a composite dielectric material or a dielectric material with a dielectric constant greater than 1, and different shapes, different materials and different dielectric constants of the dielectric resonator will also affect the span of frequency between the fundamental mode and the high-order mode or the span of frequency between the high-order mode and higher-order mode.

Optionally, the support frame is located at the face, edge or sharp corner of the dielectric resonator or at the sharp corner of the cavity, and is arranged between the dielectric resonator and the cavity, the dielectric resonator is supported by the support frame in the cavity, the support frame and the dielectric resonator or the cavity are combined to form an integrated structure or a split structure, the support frame is made of a dielectric material, and the material of the support frame is air, plastic, ceramic or a composite dielectric material, when the support frame is installed on different positions of the dielectric resonator, the corresponding the span of frequency between the fundamental mode and the high-order mode or the span of frequency between the high-order mode and the higher-order mode will also be different, and different materials of the support frame, different dielectric constants and different structures will also affect the span of frequency between the fundamental mode and the high-order mode or the span of frequency between the high-order mode and the higher-order mode.

Optionally, the support frame is connected to the dielectric resonator and the cavity by means of crimping, bonding, splicing, welding, buckling or screw connection, the support frame is connected to one or more faces of the uniaxial dielectric resonator or the vertically intersecting uniaxial dielectric resonators or the three vertically intersecting uniaxial dielectric resonators, the dielectric or metal connecting block fixes small dielectric resonant blocks after cutting by means of crimping, bonding, splicing, welding, buckling or screw connection, the connecting block connects a plurality of small dielectric resonant blocks of any shape to form a dielectric resonator, the support frame is installed at any position between the dielectric resonator and the inner wall of the cavity, matches any shape of the dielectric resonator and the cavity, and is connected and fixed, the support frame includes a solid body with two parallel sides or a structure with a penetrated middle, the number of support frames on the same face or different faces, edges or sharp corners of the dielectric resonator is one or multiple different combinations, and different numbers of support frames have different frequency spans between the fundamental mode and the high-order mode or between the high-order mode and the higher-order mode.

Optionally, the support frame of the dielectric resonator is in contact with the inner wall of the cavity to form heat conduction.

According to a dielectric filter in an embodiment of the present invention, a uniaxial dielectric resonant structure for controlling harmonic distances, a vertically intersecting biaxial dielectric resonant structure for controlling harmonic distances or a vertical triaxial dielectric resonant structure for controlling harmonic distances can form 1-N single-passband filters with different frequencies, the single-passband filters with different frequencies form any combinations of multi-passband filters, duplexers or multiplexers, and the corresponding dielectric resonant structure for controlling harmonic distances can also be combined with metal or dielectric single-mode resonant cavities, dual-mode resonant cavities and triple-mode resonant cavities in different forms, so as to form multiple required single-passband or multi-passband filters or duplexers or multiplexers or any combinations with different dimensions.

Optionally, the cavity corresponding to the uniaxial dielectric resonant structure for controlling harmonic distances, the vertically intersecting biaxial dielectric resonant structure for controlling harmonic distances or the vertical triaxial dielectric resonant structure for controlling harmonic distances may be combined with a single-mode or multi-mode cavity of a metal resonator or the single-mode or multi-mode cavity of a dielectric resonator, so as to form combinations of any adjacent coupling or cross coupling.

Compared with the related art, the dielectric resonator in the embodiment of the present invention is partially provided with the blind slot, the through slot, the blind hole or the through hole, or is provided with the protrusion on its surface; or, the slots, holes or protrusions are symmetrically formed in the axial direction of the dielectric resonator; or, the slots or holes are formed in any surface, edge or corner of the dielectric resonator; or, the protrusion is arranged on the surface of the dielectric resonator. The dielectric resonator is partially provided with the blind slot, the through slot, the blind hole or the through hole, or is provided with the protrusion on its surface, so as to change the span of frequency between the fundamental mode and the high-order mode or between the high-order mode and the higher-order mode, such that the dielectric resonator can push the harmonic waves away to reduce the impact of the harmonic waves on the operating frequency performance. In the dielectric resonant structure of the present application, when the set materials and dimensions of the cavity, the dielectric resonator and the support frame remain unchanged, most filters require the frequency of the high-order mode to be as far away from a passband as possible, so as to reduce the interference to a main passband. A few filters require the frequency of the high-order mode to be close to the passband, so as to form a multi-passband filter. The dielectric resonator of the present application is capable of conveniently controlling harmonic distances of the filter and flexibly changing the attenuation performance outside the passband.

### BRIEF DESCRIPTION OF THE DRAWINGS

To illustrate technical solutions in the embodiments of the present invention or in the prior art more clearly, a brief introduction on the drawings which are needed in the description of the embodiments or the prior art is given below. Apparently, the drawings in the description below are merely some of the embodiments of the present invention, based on which other drawings can be obtained by those of ordinary skill in the art without any creative effort.

FIG. 1 is a schematic structural diagram of a uniaxial dielectric resonator provided in a first embodiment of the present invention;

FIG. 2 is a schematic structural diagram of a uniaxial dielectric resonator provided in a second embodiment of the present invention;

FIG. 3 is a schematic structural diagram of a uniaxial dielectric resonator provided in a third embodiment of the present invention;

FIG. 4 is a schematic structural diagram of a uniaxial dielectric resonator provided in a fourth embodiment of the present invention;

FIG. 5 is a schematic structural diagram of a uniaxial dielectric resonator provided in a fifth embodiment of the present invention;

FIG. 6 is a schematic structural diagram of a uniaxial dielectric resonator provided in a sixth embodiment of the present invention;

FIG. 7 is a schematic structural diagram of a uniaxial dielectric resonator provided in a seventh embodiment of the present invention;

FIG. 8 is a schematic structural diagram of a uniaxial dielectric resonator provided in an eighth embodiment of the present invention;

FIG. 9 is a schematic structural diagram of a cylindrical uniaxial dielectric resonator according to the present invention;

FIG. 10 is a schematic structural diagram of two vertically intersecting cylindrical uniaxial dielectric resonators according to the present invention;

FIG. 11 is a schematic structural diagram of three vertically intersecting cylindrical uniaxial dielectric resonators according to the present invention;

FIG. 12 is a schematic diagram of a simulation data line of a uniaxial dielectric resonator according to the present invention;

FIG. 13 is a schematic diagram of simulation data lines of two vertically intersecting cylindrical uniaxial dielectric resonators according to the present invention; and

FIG. 14 is a schematic diagram of simulation data lines of three vertically intersecting cylindrical uniaxial dielectric resonators according to the present invention.

### DETAILED DESCRIPTION OF THE EMBODIMENTS

In order to make the purposes, technical solutions and advantages of the embodiments of the present invention clearer, the technical solutions in the embodiments of the present invention will be clearly and completely described below with reference to the drawings in the embodiments of the present invention. Obviously, the described embodiments are some embodiments of the present invention, but not all embodiments. Based on the embodiments in the present invention, all other embodiments, obtained by those of ordinary skill in the art without creative effort, shall fall within the protection scope of the present invention.

In the description of the present invention, it should be understood that orientation or position relationships indicated by the terms “length”, “width”, “upper”, “lower”, “front”, “rear”, “left”, “right”, “vertical”, “horizontal”, “top”, “bottom”, “inside”, “outside” and the like are based on the orientation or position relationships shown in the drawings, which are only for the convenience of describing the present invention and simplifying the description, rather than indicating or implying that a referred device or element must have a particular orientation, or be constructed and operate in a particular orientation, and thus cannot be construed as limitations of the present invention.

In addition, the terms “first” and “second” are only used for descriptive purposes, and should not be construed as indicating or implying relative importance or implying the number of indicated technical features. Thus, a feature carrying “first” or “second” may expressly or implicitly include one or more features. In the description of the present invention, “plurality” means two or more, unless otherwise expressly and specifically defined.

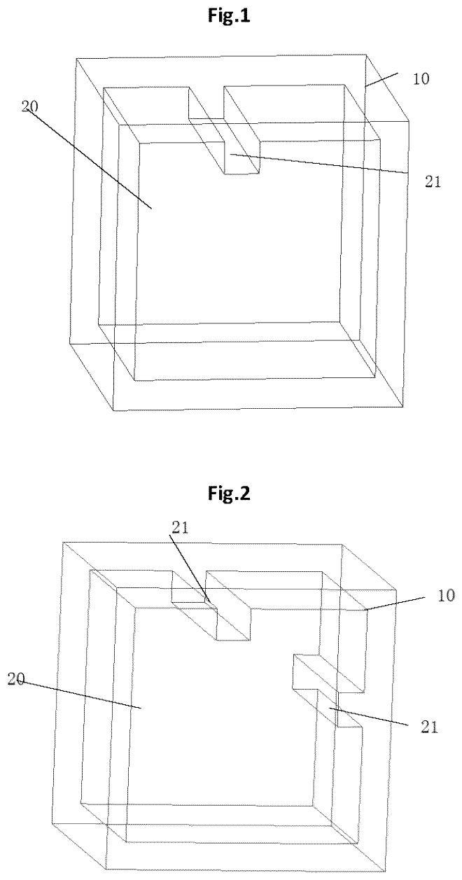

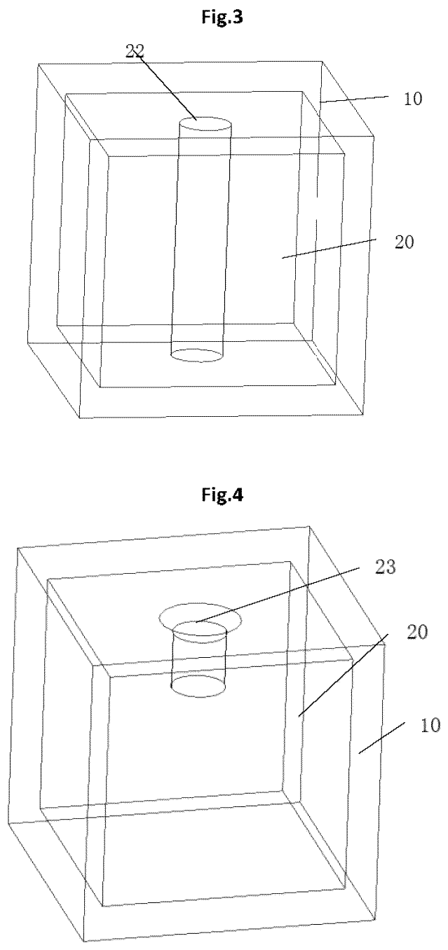

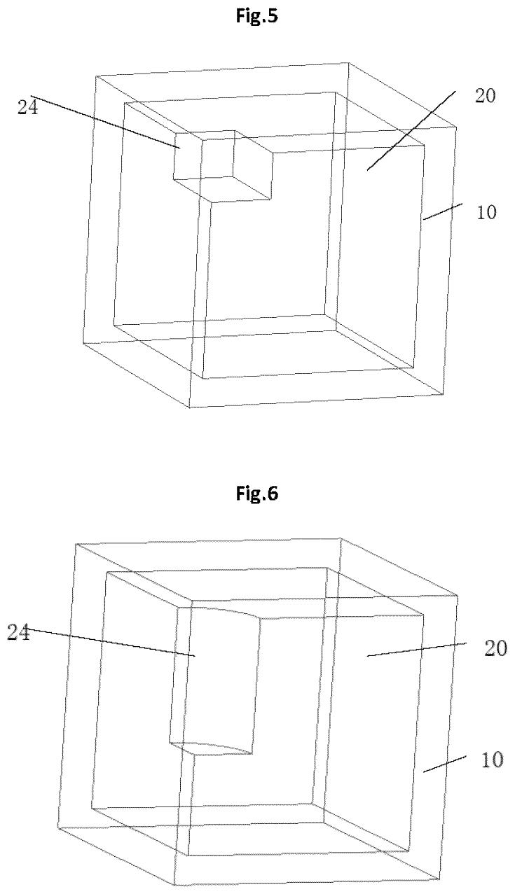

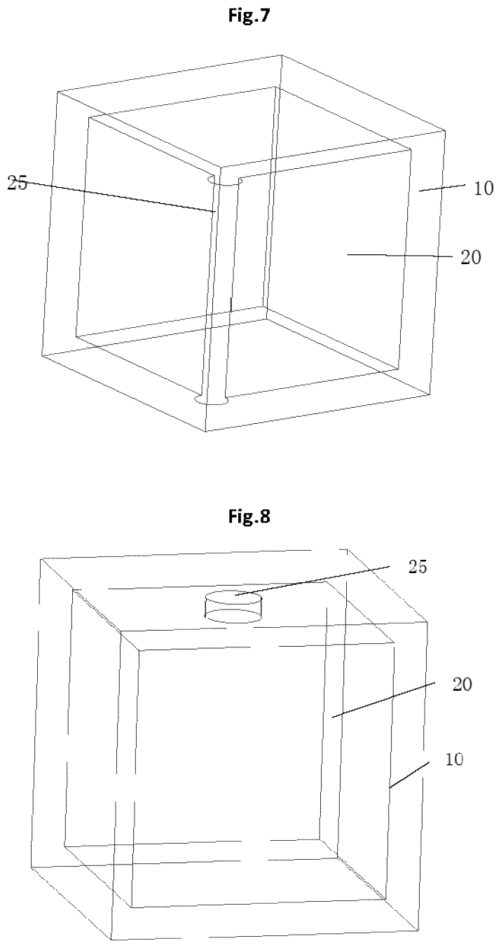

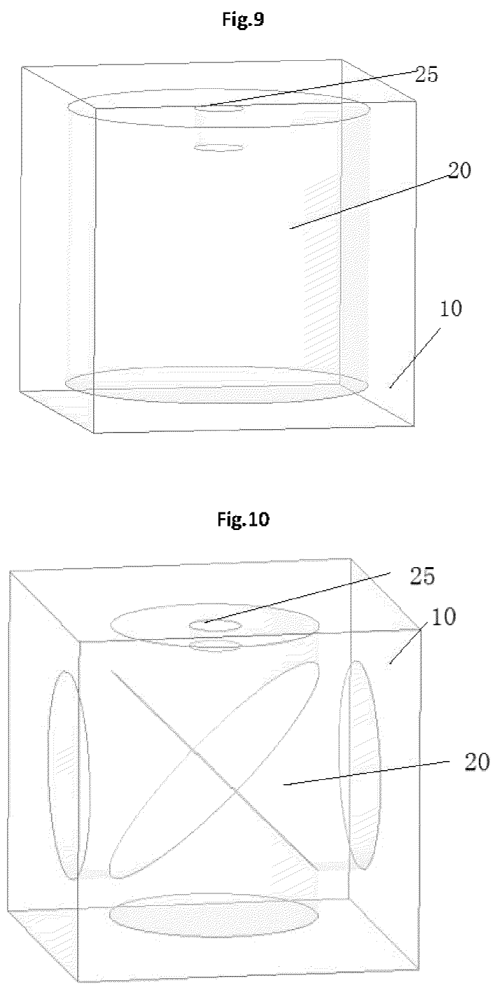

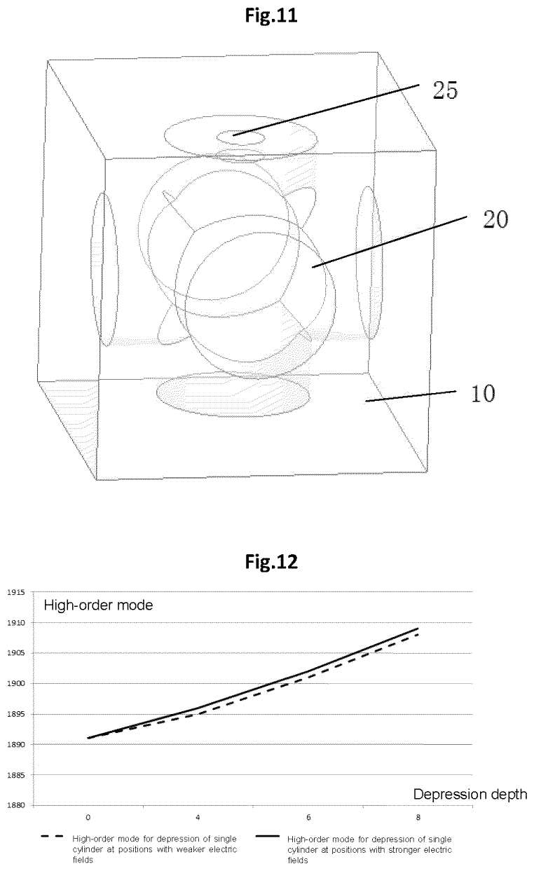

Referring to FIGS. 1 to 11, an embodiment of the present invention provides a dielectric resonant structure for controlling harmonic distances, including a cavity 10, a support frame (not shown), a dielectric resonator 20 and a cover plate (not shown), wherein the cavity 10 is composed of a sealed space, and one surface of the cavity 10 is a cover plate surface; the dielectric resonator 20 is composed of a dielectric; the dielectric resonator 20 is installed in the cavity 10 and is not in contact with an inner wall of the cavity 10; the support frame is installed at any position between the dielectric resonator 20 and the inner wall of the cavity 10, matches any shape of the dielectric resonator 20 and the cavity 10, and is connected to and fixed with the dielectric resonator 20 for supporting the same; the cavity 10 is internally provided with a uniaxial cylindrical or polygonal dielectric resonator 20 and the support frame fixed thereon, so as to form a multi-mode dielectric resonant structure with the cavity 10, wherein the dielectric resonator 20 is partially provided with a blind slot 24, a through slot 21, a blind hole 23 or a through hole 22, or is provided with a protrusion 25 on its surface; or, slots, holes or protrusions 25 are symmetrically formed in the axial direction of the dielectric resonator; or, slots or holes are formed in any surface, edge or corner of the dielectric resonator; or, a protrusion 25 is arranged on the surface of the dielectric resonator. The dielectric resonator 20 is partially provided with the blind slot 24, the through slot 21, the blind hole 23 or the through hole 22, or is provided with the protrusion 25 on its surface, so as to change the span of frequency between a fundamental mode and a high-order mode or the span of frequency between the high-order mode and a higher-order mode.

When the cavity 10 is internally provided with two vertically intersecting cylindrical or polygonal uniaxial dielectric resonators 20 and the support frame fixed thereon, so as to form a multi-mode dielectric resonant structure with the cavity 10, an X axis dimension of the cylindrical or polygonal dielectric resonator 20 on an X axis is greater than or equal to a dimension, in a vertical direction and parallel to the X axis, of the cylindrical or polygonal dielectric resonator 20 on a Y axis; a Y axis dimension of the cylindrical or polygonal dielectric resonator 20 on the Y axis is greater than or equal to a dimension, in the vertical direction and parallel to the Y axis, of the cylindrical or polygonal dielectric resonator 20 on the X axis, wherein the dielectric resonator 20 is partially provided with the blind slot 24, the through slot 21, the blind hole 23 or the through hole 22, or is provided with the protrusion 25 on its surface; or, slots, holes or protrusions 25 are symmetrically formed in the axial direction of the dielectric resonator; or, slots or holes are formed in any surface, edge or corner of the dielectric resonator; or, the protrusion 25 is arranged on the surface of the dielectric resonator. The dielectric resonator 20 is partially provided with the blind slot 24, the through slot 21, the blind hole 23 or the through hole 22, or is provided with the protrusion 25 on its surface, so as to change the span of frequency between the fundamental mode and the high-order mode or the span of frequency between the high-order mode and the higher-order mode.

When the cavity 10 is internally provided with three vertically intersecting cylindrical or polygonal uniaxial dielectric resonators 20 and the support frame fixed thereon, so as to form a multi-mode dielectric resonant structure with the cavity 10, the X axis dimension of the cylindrical or polygonal dielectric resonator 20 on the X axis is greater than or equal to the dimensions, in the vertical direction and parallel to the X axis, of the cylindrical or polygonal dielectric resonator 20 on the Y axis and the cylindrical or polygonal dielectric resonator 20 on a Z axis; the Y axis dimension of the cylindrical or polygonal dielectric resonator 20 on the Y axis is greater than or equal to the dimensions, in the vertical direction and parallel to the Y axis, of the cylindrical or polygonal dielectric resonator 20 on the X axis and the cylindrical or polygonal dielectric resonator 20 on the Z axis; a Z axis dimension of the cylindrical or polygonal dielectric resonator 20 on the Z axis is greater than or equal to the dimensions, in the vertical direction and parallel to the Z axis, of the cylindrical or polygonal dielectric resonator 20 on the X axis and the cylindrical or polygonal dielectric resonator 20 on the Y axis, wherein the dielectric resonator 20 is partially provided with the blind slot 24, the through slot 21, the blind hole 23 or the through hole 22, or is provided with the protrusion 25 on its surface; or, slots, holes or protrusions 25 are symmetrically formed in the axial direction of the dielectric resonator; or, slots or holes are formed in any surface, edge or corner of the dielectric resonator; or, the protrusion 25 is arranged on the surface of the dielectric resonator. The dielectric resonator 20 is partially provided with the blind slot 24, the through slot 21, the blind hole 23 or the through hole 22, or is provided with the protrusion 25 on its surface, so as to change the span of frequency between the fundamental mode and the high-order mode or the span of frequency between the high-order mode and the higher-order mode.

The dielectric resonant structure is composed of a uniaxial dielectric resonator 20, vertically intersecting uniaxial dielectric resonators 20 or three vertically intersecting uniaxial dielectric resonators 20, slots or holes are formed in corners, edges, surfaces or interior of the dielectric resonator 20, and a plurality of slots or holes are symmetrically formed in different corners, edges and surfaces; or, a plurality of slots or holes are formed in the same surface; or, slots or holes are formed inside the dielectric resonator; or, slots or holes are symmetrically formed in different axial directions thereof.

The slot or hole formed in the dielectric resonator 20 is set as the blind slot 24, the blind hole 23, the through slot 21 or the through hole 22, and under the condition that the frequency of the fundamental mode is kept unchanged, the dimension of the dielectric resonator 20 changes after the slot and the hole are formed, so as to change the span of frequency between the fundamental mode and the high-order mode or the span of frequency between the high-order mode and the higher-order mode.

The protrusion 25 may also be arranged at any position on any of the surfaces of the dielectric resonator 20, the protrusion 25 is a cuboid, a cylinder or an irregular shape, and under the condition that the frequency of the fundamental mode is kept unchanged, the dimension of the dielectric resonator 20 changes after the protrusion 25 is arranged, so as to change the span of frequency between the fundamental mode and the high-order mode or the span of frequency between the high-order mode and the higher-order mode.

When the dielectric resonant structure is composed of a uniaxial dielectric resonator 20, vertically intersecting uniaxial dielectric resonators 20 or three vertically intersecting uniaxial dielectric resonators 20, horizontal and vertical dimensions of the dielectric resonator 20 are trimmed, slotted and chamfered, so that the dimension of the inner wall of the cavity 10 and the dimensions of three corresponding axial dielectric resonators 20 are changed, or dimensions in the horizontal and vertical directions of the dielectric resonators 20 are changed, so as to change the frequency of the fundamental mode and the frequency of multiple high-order modes, as well as the corresponding number of multi-modes and Q values; and when the dielectric resonant structure is composed of vertically intersecting uniaxial dielectric resonators 20 or three vertically intersecting uniaxial dielectric resonators 20, and when the dimension of any axial cylindrical or polygonal dielectric resonator 20 is less than the dimension, in the vertical direction and parallel to the axial direction, of the other one or two axial cylindrical or polygonal dielectric resonators 20, the frequency of the corresponding fundamental mode and the frequency of multiple high-order modes, as well as the corresponding number of multi-modes and the Q values change accordingly, when the frequency of the fundamental mode is kept constant, in the dielectric resonator structure for controlling harmonic distances, which is composed of the dielectric resonators 20 with different dielectric constants, the cavity 10 and the support frame, the number of the multi-modes and the Q values corresponding to the frequency of the fundamental mode and the frequency of multiple high-order modes will change, the Q values of the dielectric resonators 20 with different dielectric constants will change differently, and meanwhile, the frequency of the high-order mode will also change.

The cavity 10 is internally provided with a uniaxial cylindrical or polygonal dielectric resonator 20 and the support frame fixed thereon, so as to form a multi-mode dielectric resonant structure with the cavity 10, the center of an face of the dielectric resonator 20 approaches to or coincides with a central position of a corresponding inner wall surface of the cavity 10, the horizontal and vertical dimensions of the dielectric resonator 20 are trimmed, slotted and chamfered, so that the dimension of the inner wall of the cavity 10 and the dimensions of three corresponding axial dielectric resonators 20 are changed or dimensions in the horizontal and vertical directions of the dielectric resonators 20 are changed, so as to change the frequency of the fundamental mode and the frequency of multiple high-order modes, as well as the corresponding number of multi-modes and Q values, when the X axis, Y axis and Z axis dimensions of the inner wall of the cavity 10 change, and when at least one required frequency is kept unchanged, the X axis, Y axis and Z axis dimensions of the dielectric resonator 20 corresponding to the inner wall of the cavity 10 will also change accordingly; the cavity 10 is internally provided with two vertically intersecting uniaxial cylindrical or polygonal dielectric resonators 20 and the support frame fixed thereon, so as to form a multi-mode dielectric resonant structure with the cavity 10, the center of the face of the dielectric resonator 20 approaches to or coincides with the central position of the corresponding inner wall surface of the cavity 10, wherein the X axis dimension of the cylindrical or polygonal dielectric resonator 20 on the X axis is greater than or equal to the dimension, in the vertical direction and parallel to the X axis, of the cylindrical or polygonal dielectric resonator 20 on the Y axis, and the Y axis dimension of the cylindrical or polygonal dielectric resonator 20 on the Y axis is greater than or equal to the dimension, in the vertical direction and parallel to the Y axis, of the cylindrical or polygonal dielectric resonator 20 on the X axis; the horizontal and vertical dimensions of the dielectric resonator 20 are trimmed, slotted and chamfered, so that the dimension of the inner wall of the cavity 10 and the dimensions of three corresponding axial dielectric resonators 20 are changed or dimensions in the horizontal and vertical directions of the dielectric resonators 20 are changed, so as to change the frequency of the fundamental mode and the frequency of multiple high-order modes, as well as the corresponding number of multi-modes and the Q values, when the X axis, Y axis and Z axis dimensions of the inner wall of the cavity 10 change, and when the required frequency is kept unchanged, the X axis, Y axis and Z axis dimensions of the dielectric resonator 20 corresponding to the inner wall of the cavity 10 will also change accordingly; the cavity 10 is internally provided with three vertically intersecting uniaxial cylindrical or polygonal dielectric resonators 20 and the support frame fixed thereon, so as to form a multi-mode dielectric resonant structure with the cavity 10, the center of the face of the dielectric resonator 20 approaches to or coincides with the central position of the corresponding inner wall surface of the cavity 10, wherein the X axis dimension of the cylindrical or polygonal dielectric resonator 20 on the X axis is greater than or equal to the dimensions, in the vertical direction and parallel to the X axis, of the cylindrical or polygonal dielectric resonator 20 on the Y axis and the cylindrical or polygonal dielectric resonator 20 on the Z axis; the Y axis dimension of the cylindrical or polygonal dielectric resonator 20 on the Y axis is greater than or equal to the dimensions, in the vertical direction and parallel to the Y axis, of the cylindrical or polygonal dielectric resonator 20 on the X axis and the cylindrical or polygonal dielectric resonator 20 on the Z axis; the Z axis dimension of the cylindrical or polygonal dielectric resonator on the Z axis is greater than the dimensions, in the vertical direction and parallel to the Z axis, of the cylindrical or polygonal dielectric resonator 20 on the X axis and the cylindrical or polygonal dielectric resonator 20 on the Y axis; and the horizontal and vertical dimensions of the dielectric resonator 20 are trimmed, slotted and chamfered, so that the dimension of the inner wall of the cavity 10 and the dimensions of three corresponding axial dielectric resonators 20 are changed or dimensions in the horizontal and vertical directions of the dielectric resonators 20 are changed, so as to change the frequency of the fundamental mode and the frequency of multiple high-order modes, as well as the corresponding number of multi-modes and the Q values, when the X axis, Y axis and Z axis dimensions of the inner wall of the cavity 10 change, and when the required frequency is kept unchanged, the X axis, Y axis and Z axis dimensions of the dielectric resonator 20 corresponding to the inner wall of the cavity 10 will also change accordingly.

In the case of a uniaxial dielectric resonant structure or vertically intersecting uniaxial dielectric resonant structures or three vertically intersecting uniaxial dielectric resonant structures, the dielectric resonator 20 is partially provided with slots or holes, wherein when the slots or holes are formed in an electric field dispersion area of an adjacent high-order mode, the span of frequency between the fundamental mode and the adjacent high-order mode or the span of frequency between the high-order mode and the higher-order mode is less than the span of frequency when the slots or holes are formed in an electric field concentration area; when the slots or holes are formed in the electric field concentration area of the adjacent high-order mode, the span of frequency between the fundamental mode and the adjacent high-order mode or the span of frequency between the high-order mode and the higher-order mode is greater than the span of frequency when the slots or holes are formed in the electric field dispersion area, the dielectric resonator 20 is partially provided with slots or holes, and if the volume occupied by the slots or holes is small, the span of frequency between the fundamental mode and the adjacent high-order mode or the span of frequency between the high-order mode and the higher-order mode is small; if the volume occupied by the slots or holes is large, the span of frequency between the fundamental mode and the adjacent high-order mode or the span of frequency between the high-order mode and the higher-order mode is large; if the number of the slots or holes is small, the span of frequency between the fundamental mode and the adjacent high-order mode or the span of frequency between the high-order mode and the higher-order mode is small; and if the number of the slots or holes is large, the span of frequency between the fundamental mode and the adjacent high-order mode or the span of frequency between the high-order mode and the higher-order mode is large.

In the case of the uniaxial dielectric resonant structure or the vertically intersecting uniaxial dielectric resonant structures or the three vertically intersecting uniaxial dielectric resonant structures, the dielectric resonator 20 is partially provided with protrusions 25, when the protrusions 25 are arranged in the electric field dispersion area of the high-order mode, the span of frequency between the fundamental mode and the adjacent high-order mode or the span of frequency between the high-order mode and the higher-order mode is greater than the span of frequency when the protrusions 25 are arranged in the electric field concentration area; when the protrusions 25 are arranged in the electric field concentration area of the high-order mode, the span of frequency between the fundamental mode and the adjacent high-order mode or the span of frequency between the high-order mode and the higher-order mode is less than the span of frequency when the protrusions 25 are arranged in the electric field dispersion area, the dielectric resonator 20 is partially provided with the protrusions 25, and if the volume occupied by the area of the protrusions 25 is small, the span of frequency between the fundamental mode and the adjacent high-order mode or the span of frequency between the high-order mode and the higher-order mode is small; and if the volume occupied by the area of the protrusions 25 is large, the span of frequency between the fundamental mode and the adjacent high-order mode or the span of frequency between the high-order mode and the higher-order mode is large.

In the case of the uniaxial dielectric resonant structure or the vertically intersecting uniaxial dielectric resonant structures or the three vertically intersecting uniaxial dielectric resonant structures, when the dimension of the inner wall of the cavity 10 and the dimensions of three corresponding axial dielectric resonators 20 are changed or dimensions in the horizontal and vertical directions of the dielectric resonators 20 are changed, the number of multi-modes and the Q values corresponding to the frequency of the fundamental mode and the frequency of multiple high-order modes will change, the Q values of the dielectric resonators 20 with different dielectric constants will change differently, when the frequency of the fundamental mode is kept unchanged, the span of frequency between the high-order mode and the fundamental mode, and the span of frequency between the high-order mode and the higher-order mode will change multiple times, the span of frequency of the dielectric resonators 20 with different dielectric constants also change differently, wherein the size of the Q value changes when the ratios of the dimension of the inner wall of the cavity 10 to the dimensions of the three corresponding axial dielectric resonators 20 or the horizontal and vertical dimensions are certain ratios, the size of the Q value is proportional to a change in the size of the dimension ratio, or the size of the Q value is proportional to the change in the size of the dimension ratio and the Q value has greater changes in the vicinity of several certain specific ratios, the multi-mode Q values corresponding to different frequencies change differently in the vicinity of the several certain specific ratios, when the dimension of the cavity 10 and the frequency of the fundamental mode are kept unchanged, and when the horizontal and vertical dimensions of the three axial dimensions of the uniaxial dielectric resonator 20 are arbitrarily combined for change, the fundamental mode of the uniaxial dielectric resonant structure can form 1-3 multi-modes with the same frequency or similar frequency, and multiple high-order modes with different frequencies form 1-N multi-modes under the same frequency; and the fundamental mode of a vertically intersecting biaxial dielectric resonator structure or vertically intersecting triaxial dielectric resonator structure can form 1-6 multi-modes with the same frequency or similar frequency, multiple high-order modes with different frequencies form 1-N multi-modes under the same frequency, and in the case of a change in the dimension of the cavity that corresponds to one axial dielectric resonator 20 or the other one or two axial dielectric resonators 20 or three axial dielectric resonators 20, the corresponding the span of frequency between the fundamental mode and the high-order mode or the span of frequency between the high-order mode and the higher-order mode, the Q value and the modulus will also change accordingly.

Edges or sharp corners of the dielectric resonator 20 or/and the cavity 10 are trimmed to form adjacent coupling, the cavity 10 and the dielectric resonator 20 are cut into triangles or quadrilaterals, or the edges of the cavity 10 and the dielectric resonator 20 are partially or completely cut off, the cavity 10 and the dielectric resonator 20 are trimmed at the same time or separately, after the adjacent coupling is formed by trimming, the frequency and the Q value will change correspondingly, the adjacent coupling changes its cross coupling, a sharp corner position of a three-sided intersection of the cavity 10 corresponding to the uniaxial dielectric resonator 20 or the vertically intersecting uniaxial dielectric resonators 20 or the three vertically intersecting uniaxial dielectric resonators 20 is chamfered or/and is chamfered with the cavity 10 and closed to form cross coupling, and the corresponding frequency and the Q value will also change correspondingly, the adjacent coupling will be changed at the same time, and when the dielectric resonator is provided with the slots or holes or protrusions 25 at the corners and edges, the strength of the adjacent coupling and the cross coupling will be changed.

Optionally, the shape of the cavity 10 corresponding to the uniaxial dielectric resonant structure or the vertically intersecting uniaxial dielectric resonant structures or the three vertically intersecting uniaxial dielectric resonant structures includes, but is not limited to, a cuboid, a cube and a polygon, the inner wall surface or an inner area of the cavity 10 can be partially provided with a depression or a protrusion 25 or a cut corner or a slot, at least one tuning device is arranged at a field strength concentration position of the dielectric resonator 20 and is installed on the cavity 10, the material of the cavity 10 is metal or non-metal, and the surface of the space is electroplated with copper or silver.

A cross-sectional shape of the uniaxial dielectric resonator 20 or the vertically intersecting uniaxial dielectric resonators 20 or the three vertically intersecting uniaxial dielectric resonators 30 includes, but is not limited to, a cylinder, an ellipsoid and a polygon, and slots or holes are formed in the corners, edges or surfaces of the dielectric resonator 20; or, a plurality of slots or holes are symmetrically formed in different corners, edges and surfaces; or, a plurality of slots or holes are formed in the same surface; or, slots or holes are formed inside the dielectric resonator; or, slots or holes are symmetrically formed in different axial directions of the dielectric resonator; or, a plurality of slots or holes are formed in the same surface; or, protrusions 25 are arranged on the surface of the dielectric resonator; or, different numbers of protrusions 25 are arranged at any position on any surface of the dielectric resonator, the uniaxial dielectric resonator 20 or the vertically intersecting uniaxial dielectric resonators 20 or the three vertically intersecting uniaxial dielectric resonators 20 are solid or hollow, the dielectric resonator 20 is made of ceramics, a composite dielectric material or a dielectric material with a dielectric constant greater than 1, and different shapes, different materials and different dielectric constants of the dielectric resonator 20 will also affect the span of frequency between the fundamental mode and the high-order mode or the span of frequency between the high-order mode and higher-order mode.

The support frame is located at the face, edge or sharp corner of the dielectric resonator 20 or at the sharp corner of the cavity 10, and is arranged between the dielectric resonator 20 and the cavity, the dielectric resonator 20 is supported by the support frame in the cavity, the support frame and the dielectric resonator 20 or the cavity 10 are combined to form an integrated structure or a split structure, the support frame is made of a dielectric material, and the material of the support frame is air, plastic, ceramic or a composite dielectric material, when the support frame is installed on different positions of the dielectric resonator 20, the corresponding the span of frequency between the fundamental mode and the high-order mode or the span of frequency between the high-order mode and the higher-order mode will also be different, and different materials of the support frame, different dielectric constants and different structures will also affect the span of frequency between the fundamental mode and the high-order mode or the span of frequency between the high-order mode and the higher-order mode.

The support frame is connected to the dielectric resonator 20 and the cavity 10 by means of crimping, bonding, splicing, welding, buckling or screw connection, the support frame is connected to one or more faces of the uniaxial dielectric resonator 20 or the vertically intersecting uniaxial dielectric resonators 20 or the three vertically intersecting uniaxial dielectric resonators 20, the dielectric or metal connecting block fixes small dielectric resonant blocks after cutting by means of crimping, bonding, splicing, welding, buckling or screw connection, the connecting block connects a plurality of small dielectric resonant blocks of any shape to form a dielectric resonator 20, the support frame is installed at any position between the dielectric resonator 20 and the inner wall of the cavity 10, matches any shape of the dielectric resonator 20 and the cavity 10, and is connected and fixed, the support frame includes a solid body with two parallel sides or a structure with a penetrated middle, the number of support frames on the same face or different faces, edges or sharp corners of the dielectric resonator 20 is one or multiple different combinations, and different numbers of support frames have the different span of frequency between the fundamental mode and the high-order mode or between the high-order mode and the higher-order mode. The support frame of the dielectric resonator 20 is in contact with the inner wall of the cavity 10 to form heat conduction.

According to a dielectric filter in an embodiment of the present invention, a uniaxial dielectric resonant structure for controlling harmonic distances, a vertically intersecting biaxial dielectric resonant structure for controlling harmonic distances or a vertical triaxial dielectric resonant structure for controlling harmonic distances can form 1-N single-passband filters with different frequencies, the single-passband filters with different frequencies form any combinations of multi-passband filters, duplexers or multiplexers, and the corresponding dielectric resonant structure for controlling harmonic distances can also be combined with single-mode resonant cavities 10, dual-mode resonant cavities 10 and triple-mode resonant cavities 10 with metal or dielectric in different forms, so as to form multiple required single-passband or multi-passband filters or duplexers or multiplexers or any combinations with different dimensions.

It is further set that, the cavity 10 corresponding to the uniaxial dielectric resonant structure for controlling harmonic distances, the vertically intersecting biaxial dielectric resonant structure for controlling harmonic distances or the vertical triaxial dielectric resonant structure for controlling harmonic distances may be combined with a single-mode or multi-mode cavity 10 of a metal resonator or the single-mode or multi-mode cavity 10 of a dielectric resonator 20, so as to form any adjacent coupling or cross coupling.

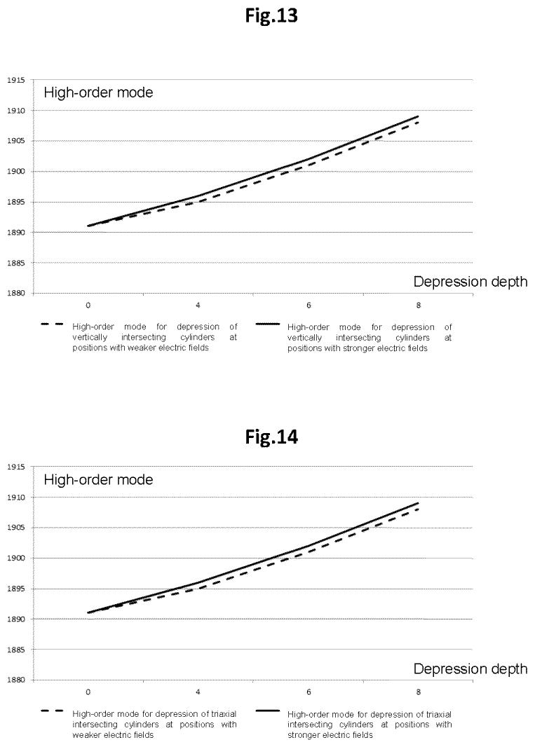

By means of the design of the length, width, height, hollow or solid and position of the dielectric resonator 20 (the length, width, height, hollow or solid and the position described herein are parameters that can be changed or adjusted in a process of designing the dielectric resonator 20, above parameters can be changed at the same time, or one of the parameters can be changed independently, or some of the parameters can be changed), so that the dielectric resonator 20 can match different frequency ranges, and for the dielectric resonator 20 with the same volume, the smaller the volume of the dielectric resonator block is, the higher the frequency of the dielectric resonator 20 can be. Since the dielectric resonator 20 has many different frequencies, due to the different frequencies, the dielectric resonator 20 also has different design sensitivity to the blind slot 24, the through slot 21, the blind hole 23, the through hole 22 or the protrusion 25 arranged on its surface. In the present application, by means of the design of the blind slot 24, the through slot 21, the blind hole 23, the through hole 22 or the protrusion 25 arranged on its surface, the required frequency is designed to be an insensitive frequency, the unwanted frequencies (i.e., harmonic waves) are pushed away, the harmonic waves usually refer to frequencies in high frequency bands, and pushing away means that the harmonic waves are kept away from the normal operating frequency of the dielectric resonator 20 as far as possible (also called high frequency attenuation). Therefore, the dielectric resonator 20 in the present application is convenient to push away the harmonic waves, which is beneficial for realizing high frequency attenuation. It can be seen from the schematic diagrams of the lines in FIGS. 12 to 14 that, when the volume of the resonator in the cavity 10 is changed smaller based on the design of the blind slot 24, the through slot 21, the blind hole 23, the through hole 22 or the protrusion 25 arranged on its surface on the uniaxial dielectric resonator 20 or the vertically intersecting uniaxial dielectric resonators 20 or the three vertically intersecting uniaxial dielectric resonators 20, the harmonic waves would be pushed away farther. When the blind slot 24, the through slot 21, the blind hole 23, or the through hole 22 on the dielectric resonator 20 or the protrusion 25 arranged on its surface are formed closer to an electric field, the harmonic waves are pushed away farther.

The device embodiments described above are merely exemplary, wherein units described as separate components can be separated physically or not, components displayed as units can be physical units or not, namely, can be located in one place, or can also be distributed on a plurality of network units. Part of or all the modules can be selected to achieve the purposes of the solutions in the embodiments according to actual demands. Those of ordinary skill in the art can understand and implement the purposes without any creative effort.

Finally, it should be noted that the above embodiments are merely used for illustrating the technical solutions of the present invention, rather than limiting them; although the present invention has been described in detail with reference to the foregoing embodiments, those of ordinary skill in the art should understand that they could still make modifications to the technical solutions recorded in the foregoing embodiments or make equivalent substitutions to part of or all the technical features; and these modifications or substitutions do not make the essence of the corresponding technical solutions depart from the spirit and scope of the technical solutions of various embodiments of the present invention.

### INDUSTRIAL APPLICABILITY

The dielectric resonator in the embodiment of the present invention is partially provided with the blind slot, the through slot, the blind hole or the through hole, or is provided with the protrusion on its surface; or, the slots, holes or protrusions are symmetrically formed in the axial direction of the dielectric resonator; or, the slots or holes are formed in any surface, edge or corner of the dielectric resonator; or, the protrusion is arranged on the surface of the dielectric resonator. The dielectric resonator is partially provided with the blind slot, the through slot, the blind hole or the through hole, or is provided with the protrusion on its surface, so as to change the span of frequency between the fundamental mode and the high-order mode or between the high-order mode and the higher-order mode, such that the dielectric resonator can push the harmonic waves away to reduce the impact of the harmonic waves on the operating frequency performance. In the dielectric resonant structure of the present application, when the set materials and dimensions of the cavity, the dielectric resonator and the support frame remain unchanged, most filters require the frequency of the high-order mode to be as far away from a passband as possible, so as to reduce the interference to a main passband. A few filters require the frequency of the high-order mode to be close to the passband, so as to form a multi-passband filter. The dielectric resonator of the present application is capable of conveniently controlling harmonic distances of the filter and flexibly changing the attenuation performance outside the passband.

What is claimed is:

1. A dielectric resonant structure for controlling harmonic distances, comprising a cavity, a support frame, a dielectric resonator and a cover plate, wherein the cavity is composed of a sealed space, and one surface of the cavity is a cover plate surface; the dielectric resonator is composed of a dielectric; the dielectric resonator is installed in the cavity and is not in contact with an inner wall of the cavity; the support frame is installed at any position between the dielectric resonator and the inner wall of the cavity, matches any shape of the dielectric resonator and the cavity, and is connected to, fixed with and supported the dielectric resonator;
the cavity is internally provided with a uniaxial cylindrical or polygonal dielectric resonator and the support frame fixed thereon, so as to form a multi-mode dielectric resonant structure with the cavity; or
the cavity is internally provided with two vertically intersecting cylindrical or polygonal uniaxial dielectric resonators and the support frame fixed thereon, so as to form a multi-mode dielectric resonant structure with the cavity, wherein an X axis dimension of the cylindrical or polygonal dielectric resonator on an X axis is greater than or equal to a dimension, in a vertical direction and parallel to the X axis, of the cylindrical or polygonal dielectric resonator on a Y axis, and a Y axis dimension of the cylindrical or polygonal dielectric resonator on the Y axis is greater than or equal to a dimension, in the vertical direction and parallel to the Y axis, of the cylindrical or polygonal dielectric resonator on the X axis; or
the cavity is internally provided with three vertically intersecting cylindrical or polygonal uniaxial dielectric resonators and the support frame fixed thereon, so as to form a multi-mode dielectric resonant structure with the cavity, wherein the X axis dimension of the cylindrical or polygonal dielectric resonator on the X axis is greater than or equal to the dimensions, in the vertical direction and parallel to the X axis, of the cylindrical or polygonal dielectric resonator on the Y axis and the cylindrical or polygonal dielectric resonator on a Z axis; the Y axis dimension of the cylindrical or polygonal dielectric resonator on the Y axis is greater than or equal to the dimensions, in the vertical direction and parallel to the Y axis, of the cylindrical or polygonal dielectric resonator on the X axis and the cylindrical or polygonal dielectric resonator on the Z axis; a Z axis dimension of the cylindrical or polygonal dielectric resonator on the Z axis is greater than or equal to the dimensions, in the vertical direction and parallel to the Z axis, of the cylindrical or polygonal dielectric resonator on the X axis and the cylindrical or polygonal dielectric resonator on the Y axis,
wherein the dielectric resonator is partially provided with a blind slot, a through slot, a blind hole or a through hole, or is provided with a protrusion on its surface; or, slots, holes or protrusions are symmetrically formed in the axial direction of the dielectric resonator; or, slots or holes are formed in any surface, edge or corner of the dielectric resonator; or, a protrusion is arranged on the surface of the dielectric resonator, and the dielectric resonator is partially provided with the blind slot, the through slot, the blind hole or the through hole, or is provided with the protrusion on its surface, so as to change the span of frequency between a fundamental mode and the span of frequency high-order mode or between the high-order mode and a higher-order mode.

2. The dielectric resonant structure for controlling harmonic distances according to claim 1, wherein the dielectric resonant structure is composed of a uniaxial dielectric resonator, vertically intersecting uniaxial dielectric resonators or three vertically intersecting uniaxial dielectric resonators, slots or holes are formed in corners, edges, surfaces or interior of the dielectric resonator, and a plurality of slots or holes are symmetrically formed in different corners, edges and surfaces; or, a plurality of slots or holes are formed in the same surface; or, slots or holes are formed inside the dielectric resonator; or, slots or holes are symmetrically formed in different axial directions thereof.

3. The dielectric resonant structure for controlling harmonic distances according to claim 2, wherein the slots or holes are set as blind slots, blind holes, through slots or through holes, and under the condition that the frequency of the fundamental mode is kept unchanged, the dimension of the dielectric resonator changes after the slots and the holes are formed, so as to change the span of frequency between the fundamental mode and the high-order mode or between the high-order mode and the higher-order mode.

4. The dielectric resonant structure for controlling harmonic distances according to claim 2, wherein the protrusion is arranged at any position on any of the surfaces of the dielectric resonator, the protrusion is a cuboid, a cylinder or an irregular shape, and under the condition that the frequency of the fundamental mode is kept unchanged, the dimension of the dielectric resonator changes after the protrusion is arranged, so as to change the span of frequency between the fundamental mode and the high-order mode or between the high-order mode and the higher-order mode.

5. The dielectric resonant structure for controlling harmonic distances according to claim 1, wherein when the dielectric resonant structure is composed of a uniaxial dielectric resonator, vertically intersecting uniaxial dielectric resonators or three vertically intersecting uniaxial dielectric resonators, horizontal and vertical dimensions of the dielectric resonator are trimmed, slotted and chamfered, so that the dimension of the inner wall of the cavity and the dimensions of three corresponding axial dielectric resonators are changed or the dimensions in horizontal and vertical directions of the dielectric resonators are changed, so as to change the frequency of the fundamental mode and the frequency of multiple high-order modes, as well as the corresponding number of multi-modes and Q values,
when the dielectric resonant structure is composed of vertically intersecting uniaxial dielectric resonators or three vertically intersecting uniaxial dielectric resonators, and when the dimension of any axial cylindrical or polygonal dielectric resonator is less than the dimension, in the vertical direction and parallel to the axial direction, of the other one or two axial cylindrical or polygonal dielectric resonators, the frequency of the corresponding fundamental mode and the frequency of multiple high-order modes, as well as the corresponding number of multi-modes and the Q values change accordingly, and
when the frequency of the fundamental mode is kept constant, in the dielectric resonator structure for controlling harmonic distances, which is composed of the dielectric resonators with different dielectric constants, the cavity and the support frame, the multi-modes and the Q values corresponding to the frequency of the fundamental mode and the multiple high-order modes will change, the Q values of the dielectric resonators with different dielectric constants will change differently, and meanwhile, the frequency of the high-order mode will also change.

6. The dielectric resonant structure for controlling harmonic distances according to claim 1, wherein the cavity is internally provided with a uniaxial cylindrical or polygonal dielectric resonator and the support frame fixed thereon, so as to form a multi-mode dielectric resonant structure with the cavity, the center of an face of the dielectric resonator approaches to or coincides with a central position of a corresponding inner wall surface of the cavity, the horizontal and vertical dimensions of the dielectric resonator are trimmed, slotted and chamfered, so that the dimension of the inner wall of the cavity and the dimensions of three corresponding axial dielectric resonators are changed or dimensions in the horizontal and vertical directions of the dielectric resonators are changed, so as to change the frequency of the fundamental mode and the frequency of multiple high-order modes, as well as the corresponding number of multi-modes and Q values, when the X axis, Y axis and Z axis dimensions of the inner wall of the cavity change, and when at least one required frequency is kept unchanged, the X axis, Y axis and Z axis dimensions of the dielectric resonator corresponding to the inner wall of the cavity will also change accordingly;
the cavity is internally provided with two vertically intersecting cylindrical or polygonal uniaxial dielectric resonators and the support frame fixed thereon, so as to form a multi-mode dielectric resonant structure with the cavity, the center of the face of the dielectric resonator approaches to or coincides with the central position of the corresponding inner wall surface of the cavity, wherein the X axis dimension of the cylindrical or polygonal dielectric resonator on the X axis is greater than or equal to the dimension, in the vertical direction and parallel to the X axis, of the cylindrical or polygonal dielectric resonator on the Y axis, and the Y axis dimension of the cylindrical or polygonal dielectric resonator on the Y axis is greater than or equal to the dimension, in the vertical direction and parallel to the Y axis, of the cylindrical or polygonal dielectric resonator on the X axis; the horizontal and vertical dimensions of the dielectric resonator are trimmed, slotted and chamfered, so that the dimension of the inner wall of the cavity and the dimensions of three corresponding axial dielectric resonators are changed or dimensions in the horizontal and vertical directions of the dielectric resonators are changed, so as to change the frequency of the fundamental mode and the frequency of multiple high-order modes, as well as the corresponding number of multi-modes and the Q values, when the X axis, Y axis and Z axis dimensions of the inner wall of the cavity change, and when the required frequency is kept unchanged, the X axis, Y axis and Z axis dimensions of the dielectric resonator corresponding to the inner wall of the cavity will also change accordingly;
the cavity is internally provided with three vertically intersecting cylindrical or polygonal uniaxial dielectric resonators and the support frame fixed thereon, so as to form a multi-mode dielectric resonant structure with the cavity, the center of the face of the dielectric resonator approaches to or coincides with the central position of the corresponding inner wall surface of the cavity, wherein the X axis dimension of the cylindrical or polygonal dielectric resonator on the X axis is greater than or equal to the dimensions, in the vertical direction and parallel to the X axis, of the cylindrical or polygonal dielectric resonator on the Y axis and the cylindrical or polygonal dielectric resonator on the Z axis; the Y axis dimension of the cylindrical or polygonal dielectric resonator on the Y axis is greater than or equal to the dimensions, in the vertical direction and parallel to the Y axis, of the cylindrical or polygonal dielectric resonator on the X axis and the cylindrical or polygonal dielectric resonator on the Z axis; the Z axis dimension of the cylindrical or polygonal dielectric resonator on the Z axis is greater than the dimensions, in the vertical direction and parallel to the Z axis, of the cylindrical or polygonal dielectric resonator on the X axis and the cylindrical or polygonal dielectric resonator on the Y axis; and the horizontal and vertical dimensions of the dielectric resonator are trimmed, slotted and chamfered, so that the dimension of the inner wall of the cavity and the dimensions of three corresponding axial dielectric resonators are changed or the dimensions in the horizontal and vertical directions of the dielectric resonators are changed, so as to change the frequency of the fundamental mode and the frequency of multiple high-order modes, as well as the corresponding number of multi-modes and the Q values, when the X axis, Y axis and Z axis dimensions of the inner wall of the cavity change, and when the required frequency is kept unchanged, the X axis, Y axis and Z axis dimensions of the dielectric resonator corresponding to the inner wall of the cavity will also change accordingly.

7. The dielectric resonant structure for controlling harmonic distances according to claim 1, wherein in the case of a uniaxial dielectric resonant structure or vertically intersecting uniaxial dielectric resonant structures or three vertically intersecting uniaxial dielectric resonant structures, the dielectric resonator is partially provided with slots or holes, wherein when the slots or holes are formed in an electric field dispersion area of an adjacent high-order mode, and the span of frequency between the fundamental mode and the adjacent high-order mode or the span of frequency between the high-order mode and the higher-order mode is less than the span of frequency when the slots or holes are formed in an electric field concentration area; when the slots or holes are formed in the electric field concentration area of the adjacent high-order mode, and the span of frequency between the fundamental mode and the adjacent high-order mode or the span of frequency between the high-order mode and the higher-order mode is greater than the span of frequency when the slots or holes are formed in the electric field dispersion area; and
the dielectric resonator is partially provided with slots or holes, and if the volume occupied by the slots or holes is small, the span of frequency between the fundamental mode and the adjacent high-order mode or the span of frequency between the high-order mode and the higher-order mode is small; if the volume occupied by the slots or holes is large, the span of frequency between the fundamental mode and the adjacent high-order mode or the span of frequency between the high-order mode and the higher-order mode is large; if the number of the slots or holes is small, the span of frequency between the fundamental mode and the adjacent high-order mode or the span of frequency between the high-order mode and the higher-order mode is small; and if the number of the slots or holes is large, the span of frequency between the fundamental mode and the adjacent high-order mode or the span of frequency between the high-order mode and the higher-order mode is large.

8. The dielectric resonant structure for controlling harmonic distances according to claim 1, wherein in the case of the uniaxial dielectric resonant structure or the vertically intersecting uniaxial dielectric resonant structures or the three vertically intersecting uniaxial dielectric resonant structures, the dielectric resonator is partially provided with protrusions, when the protrusions are arranged in the electric field dispersion area of the high-order mode, and the span of frequency between the fundamental mode and the adjacent high-order mode or the span of frequency between the high-order mode and the higher-order mode is greater than the span of frequency when the protrusions are arranged in the electric field concentration area; when the protrusions are arranged in the electric field concentration area of the high-order mode, and the span of frequency between the fundamental mode and the adjacent high-order mode or the span of frequency between the high-order mode and the higher-order mode is less than the span of frequency when the protrusions are arranged in the electric field dispersion area; and
the dielectric resonator is partially provided with the protrusions, and if the volume occupied by the area of the protrusions is small, the span of frequency between the fundamental mode and the adjacent high-order mode or the span of frequency between the high-order mode and the higher-order mode is small; and if the volume occupied by the area of the protrusions is large, the span of frequency between the fundamental mode and the adjacent high-order mode or the span of frequency between the high-order mode and the higher-order mode is large.

9. The dielectric resonant structure for controlling harmonic distances according to claim 1, wherein:
in the case of the uniaxial dielectric resonant structure or the vertically intersecting uniaxial dielectric resonant structures or the three vertically intersecting uniaxial dielectric resonant structures, when the dimension of the inner wall of the cavity and the dimensions of three corresponding axial dielectric resonators are changed or dimensions in the horizontal and vertical directions of the dielectric resonators are changed, the multi-modes and the Q values corresponding to the frequency of the fundamental mode and the frequency of multiple high-order modes will change, the Q values of the dielectric resonators with different dielectric constants will change differently, when the frequency of the fundamental mode is kept unchanged, the span of frequency between the high-order mode and the fundamental mode, and the span of frequency between the high-order mode and the higher-order mode will change multiple times, the span of frequency of the dielectric resonators with different dielectric constants also change differently,
wherein the size of the Q value changes when the ratios of the dimension of the inner wall of the cavity to the dimensions of the three corresponding axial dielectric resonators or the horizontal and vertical dimensions are certain ratios, the size of the Q value is proportional to a change in the size of the dimension ratio, or the size of the Q value is proportional to the change in the size of the dimension ratio and the Q value has greater changes in the vicinity of several certain specific ratios, the multi-mode Q values corresponding to different frequencies change differently in the vicinity of the several certain specific ratios,
when the dimension of the cavity and the frequency of the fundamental mode are kept unchanged, and when the horizontal and vertical dimensions of the three axial dimensions of the uniaxial dielectric resonator are arbitrarily combined for change, the fundamental mode of the uniaxial dielectric resonant structure can form 1-3 multi-modes with the same frequency or similar frequency, and multiple high-order modes with different frequencies form 1-N multi-modes under the same frequency; and the fundamental mode of a vertically intersecting biaxial dielectric resonator structure or vertically intersecting triaxial dielectric resonator structure can form 1-6 multi-modes with the same frequency or similar frequency, multiple high-order modes with different frequencies form 1-N multi-modes under the same frequency, and
in the case of a change in the dimension of the cavity that corresponds to one axial dielectric resonator and the other one or two axial dielectric resonators or three axial dielectric resonators, the corresponding the span of frequency between the fundamental mode and the high-order mode or the span of frequency between the high-order mode and the higher-order mode, the Q value and the modulus will also change accordingly.

10. The dielectric resonant structure for controlling harmonic distances according to claim 1, wherein edges or sharp corners of the cavity or/and the dielectric resonator are trimmed to form adjacent coupling, the cavity and the dielectric resonator are cut into triangles or quadrilaterals, or the edges of the cavity or the dielectric resonator are partially or completely cut off, the cavity and the dielectric resonator are trimmed at the same time or separately, after the adjacent coupling is formed by trimming, the frequency and the Q value will change correspondingly, the adjacent coupling changes its cross coupling,
a sharp corner position at the intersection of three surfaces of the cavity corresponding to the uniaxial dielectric resonator or the vertically intersecting uniaxial dielectric resonators or the three mutually vertically intersecting uniaxial dielectric resonators is chamfered or is chamfered with the cavity and closed to form cross coupling, and the corresponding frequency and the Q value will also change correspondingly, the adjacent coupling will be changed at the same time, and
when the dielectric resonator is provided with the slots or holes or protrusions at the corners and edges, the strength of the adjacent coupling and the cross coupling will be changed.

11. The dielectric resonant structure for controlling harmonic distances according to claim 1, wherein the shape of the cavity corresponding to the uniaxial dielectric resonant structure or the vertically intersecting uniaxial dielectric resonant structures or the three vertically intersecting uniaxial dielectric resonant structures comprises, but is not limited to, a cuboid, a cube and a polygon, the inner wall surface or an inner area of the cavity can be partially provided with a depression or a protrusion or a cut corner or a slot, at least one tuning device is arranged at a field strength concentration position of the dielectric resonator and is installed on the cavity, the material of the cavity is metal or non-metal, and the surface of the space is electroplated with copper or silver.

12. The dielectric resonant structure for controlling harmonic distances according to claim 1, wherein a cross-sectional shape of the uniaxial dielectric resonator or the vertically intersecting uniaxial dielectric resonators or the three vertically intersecting uniaxial dielectric resonators comprises, but is not limited to, a cylinder, an ellipsoid and a polygon;
slots or holes are formed in the corners, edges or surfaces of the dielectric resonator; or, a plurality of slots or holes are symmetrically formed in different corners, edges and surfaces; or, a plurality of slots or holes are formed in the same surface; or, slots or holes are formed inside the dielectric resonator; or, slots or holes are symmetrically formed in different axial directions of the dielectric resonator; or, a plurality of slots or holes are formed in the same surface; or, protrusions are arranged on the surface of the dielectric resonator; or, different numbers of protrusions of a cylindrical or a polygonal are arranged at any position on any surface of the dielectric resonator;
the uniaxial dielectric resonator or the vertically intersecting uniaxial dielectric resonators or the three vertically intersecting uniaxial dielectric resonators are solid or hollow,
the dielectric resonator is made of ceramics, a composite dielectric material or a dielectric material with a dielectric constant greater than 1, and
different shapes, different materials and different dielectric constants of the dielectric resonator will also affect the span of frequency between the fundamental mode and the high-order mode or the span of frequency between the high-order mode and higher-order mode.

13. The dielectric resonant structure for controlling harmonic distances according to claim 1, wherein the support frame is located at the face, edge or sharp corner of the dielectric resonator or at the sharp corner of the cavity, and is arranged between the dielectric resonator and the cavity, the dielectric resonator is supported by the support frame in the cavity,
the support frame and the dielectric resonator or the cavity are combined to form an integrated structure or a split structure,
the support frame is made of a dielectric material, and the material of the support frame is air, plastic, ceramic or a composite dielectric material,
when the support frame is installed on different positions of the dielectric resonator, the corresponding the span of frequency between the fundamental mode and the high-order mode or the span of frequency between the high-order mode and the higher-order mode will also be different, and
different materials of the support frame, different dielectric constants and different structures will also affect the span of frequency between the fundamental mode and the high-order mode or the span of frequency between the high-order mode and the higher-order mode.

14. The dielectric resonant structure for controlling harmonic distances according to claim 13, wherein the support frame is connected to the dielectric resonator and the cavity by means of crimping, bonding, splicing, welding, buckling or screw connection, the support frame is connected to one or more faces of the uniaxial dielectric resonator or the vertically intersecting uniaxial dielectric resonators or the three vertically intersecting uniaxial dielectric resonators,
the dielectric or metal connecting block fixes small dielectric resonant blocks after cutting by means of crimping, bonding, splicing, welding, buckling or screw connection, the connecting block connects a plurality of small dielectric resonant blocks of any shape to form a dielectric resonator, and
the support frame is installed at any position between the dielectric resonator and the inner wall of the cavity, matches any shape of the dielectric resonator and the cavity, and is connected and fixed, the support frame comprises a solid body with two parallel sides or a structure with a penetrated middle, the number of support frames on the same face or different faces, edges or sharp corners of the dielectric resonator is one or multiple different combinations, and different numbers of support frames have the different span of frequency between the fundamental mode and the high-order mode or between the high-order mode and the higher-order mode.

15. The dielectric resonant structure for controlling harmonic distances according to claim 1, wherein the support frame of the dielectric resonator is in contact with the inner wall of the cavity to form heat conduction.

16. A dielectric filter comprising the dielectric resonant structure for controlling harmonic distances according to claim 1, wherein a uniaxial dielectric resonant structure for controlling harmonic distances, a vertically intersecting biaxial dielectric resonant structure for controlling harmonic distances or a vertical triaxial dielectric resonant structure for controlling harmonic distances can form 1-N single-passband filters with different frequencies, the single-passband filters with different frequencies form any combinations of multi-passband filters, duplexers or multiplexers, and the corresponding dielectric resonant structure for controlling harmonic distances can also be combined with metal or dielectric single-mode resonant cavities, dual-mode resonant cavities and triple-mode resonant cavities in different forms, so as to form multiple required single-passband or multi-passband filters or duplexers or multiplexers or any combinations with different dimensions.

17. The dielectric filter according to claim 16, wherein the cavity corresponding to the uniaxial dielectric resonant structure for controlling harmonic distances, the vertically intersecting biaxial dielectric resonant structure for controlling harmonic distances or the vertical triaxial dielectric resonant structure for controlling harmonic distances may be combined with a single-mode or multi-mode cavity of a metal resonator or the single-mode or multi-mode cavity of a dielectric resonator, so as to form combinations of any adjacent coupling or cross coupling.
